(19) United States
(12) Patent Application Publication
(10) Pub. No.: US 2007/0086850 A1
(43) Pub. Date: Apr. 19, 2007

(54) Spherical locking device

(76) Inventor: Stephen E. Ronsheim, Columbus, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/636,818

(22) Filed: Dec. 11, 2006

Related U.S. Application Data
(63) Continuation of application No. 10/728,026, filed on Dec. 4, 2003.
Application No. 10/728,026 is a continuation-in-part of application No. 10/340,128, filed on Jan. 10, 2003, now abandoned.
Application No. 10/340,128 is a continuation-in-part of application No. 10/054,046, filed on Jan. 22, 2002, now Pat. No. 6,641,323.

(51) Int. Cl. F16C 11/00

(52) U.S. Cl. 403/122

(57) ABSTRACT

A support assembly is constructed to support a part-spherical base portion of an object holding device. A cover portion cooperates with the support assembly to capture the part-spherical base portion. The object holding device also includes a mounting post which has a proximal end fixed to the part-spherical base portion and extends radially outward from the support assembly to a distal end on which to attach an object. The support assembly has a piston. Fluid pressure moves the piston member upward which applies a clamping force on the part-spherical base portion to lock the object holding device and thus the object mounted to the post.

### REFERENCES TO RELATED APPLICATIONS

This application is a continuation patent application of U.S. patent application Ser. No. 10/728,026, filed Dec. 4, 2003, which is a continuation-in-part patent application of U.S. patent application Ser. No. 10/340,128, filed Jan. 10, 2003, now pending, which is a continuation-in-part application of U.S. patent application Ser. No. 10/054,046, filed Jan. 22, 2002, now issued U.S. Pat. No. 6,641,323.

### BACKGROUND OF THE INVENTION

This invention relates generally to holding devices for objects, and more particularly to a device for holding a workpiece or other object, or for holding another workpiece holding device, in any of a variety of positions and orientations for as long as desired.

In many industries, professions, and crafts, it is essential to hold an object stationary in some selected position and orientation in space for viewing it, for viewing with it, or working on it, or somehow dealing with it. Clamps and vises are probably the most common holding devices for such purposes. But in many instances, they are not versatile enough to easily hold an object in exactly the attitude or orientation which the user needs or desires. The present invention is directed to this problem.

### BRIEF SUMMARY

Described briefly, according to various embodiments, the present invention provides an object holding device having an object mounting member with a part-spherical base portion and a mounting post portion. A support assembly is constructed to support the part-spherical base portion. A cover portion cooperates with the support assembly to capture the part-spherical base portion. The mounting post on the part-spherical base portion extends in a direction away from the part-spherical base portion and provides for attachment of an object to the object mounting member. The support assembly includes a moveable piston that applies a clamping force on the part-spherical base portion in response to fluid pressure that operates to clamp the part-spherical base portion into a selected position. When fluid pressure is not present, a spring restores the object mounting member to an unclamped position.

One object of the present invention is to provide an improved object holding device.

Related objects and advantages of the present invention will be apparent from the following description.

### BRIEF DESCRIPTION OF THE SEVERAL VIEWS OF THE DRAWINGS

FIG. 1 is a top plan view of an object holding device according to a typical embodiment of the present invention.

FIG. 2 is a section therethrough taken at line 2-2 in FIG. 1 and viewed in the direction of the arrows.

FIG. 2A is an orthographic cut-away section of the device portion above the base and taken at line 2-2 in FIG. 1 and viewed in the direction of the arrows.

FIG. 3 is a bottom plan view of the device.

FIG. 4 is a section taken at line 4-4 in Fig. 2 and viewed in the direction of the arrows.

FIG. 5 is a section taken at line 5-5 in FIG. 1 and viewed in the direction of the arrows.

FIG. 6 is a view like FIG. 2 but adding a pump assembly for a self-contained closed system incorporating a locking device according to a typical embodiment of the present invention.

FIG. 7 is a fragmentary sectional view of a second embodiment like that of FIGS. 1-5 but adding a piston return bias spring.

FIG. 8 is a sectional view similar to that of FIG. 2 but showing a third embodiment in which the clamp piston is double acting.

FIG. 9 is a sectional view similar to that of FIG. 8 but showing a fourth embodiment in which there is a piston applying bias spring whereby the device is normally locked but can be unlocked by application of fluid pressure to the piston.

FIG. 10 is a top plan view of the embodiment of FIG. 7.

FIG. 11 is a sectional view taken at line 11 - 11 in FIG. 8 and viewed in the direction of the arrows.

FIG. 12 is a sectional view showing another embodiment of the present invention in which the device can be locked upward by application of fluid pressure to a piston.

FIG. 13 is a sectional view showing yet another embodiment of the present invention in which a bias spring and bias plunger are located within a ball and post assembly.

FIG. 14 is a sectional view similar to FIG. 13 showing the piston in an unclamped position.

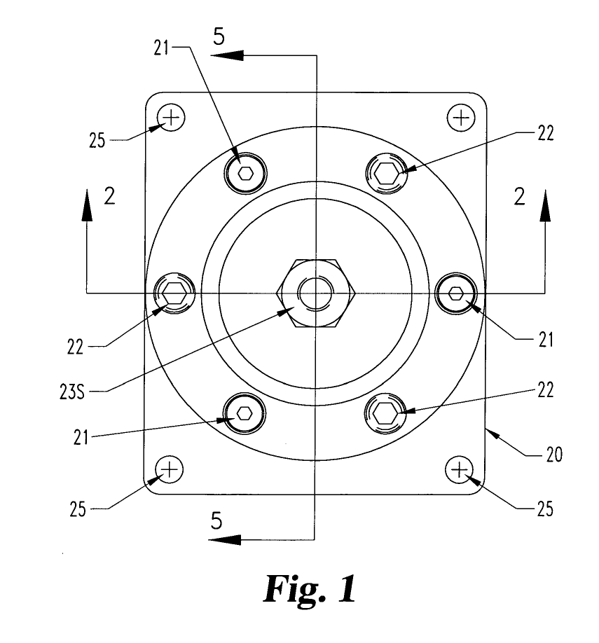

### DETAILED DESCRIPTION

For the purposes of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates are intended to be protected.

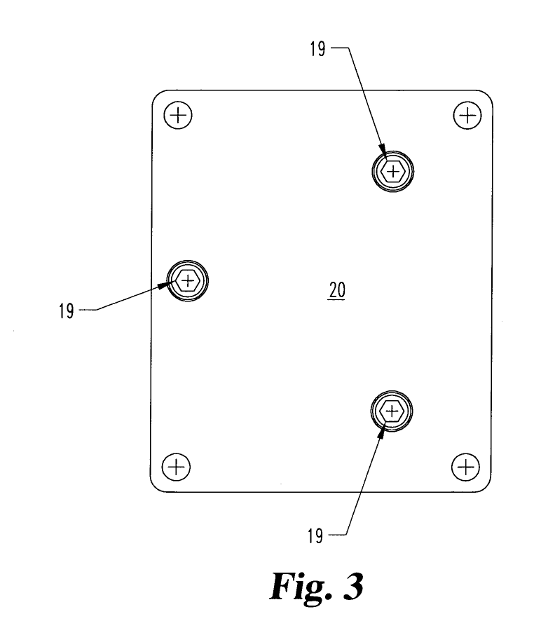

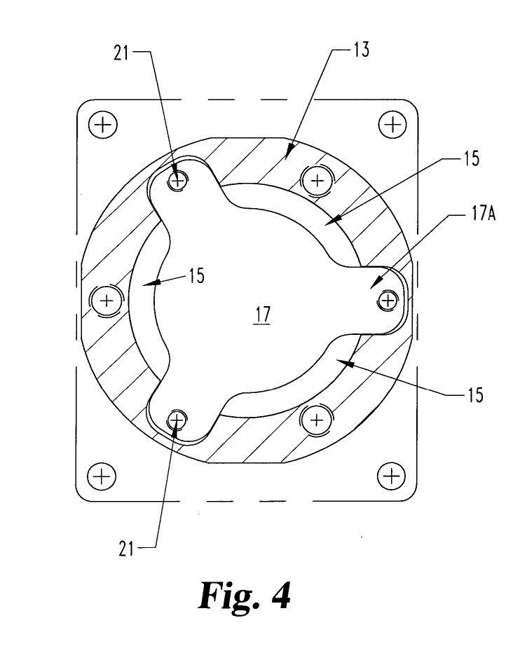

Referring now to the drawings in detail, the illustrated embodiment includes a ball 11 received in a two-part socket including an upper socket portion in a clamping plate 12, and a lower socket portion in a body 13. The body has a generally cylindrical downwardly-opening cavity 15 extending downward to the bottom edge of the body. A generally-cylindrical piston assembly is received in the cavity and includes the seal retainer cap 16 secured to the piston 17 by a socket head cap screw 18, and capturing a piston seal 14 in the annular groove formed by the circular rib 1 7R atop the piston, and the underside of the cap 16. The inner edge of the rib 1 7R forms a recess which centers the seal retainer cap on the piston. As best shown in FIG. 4, the piston 17 is formed with three circularly-spaced arms 1 7A, each of which has a threaded aperture in it receiving the threaded lower end of a socket head shoulder bolt 21 which serves as a tie rod whose head is received in a recess in the top plate 12.

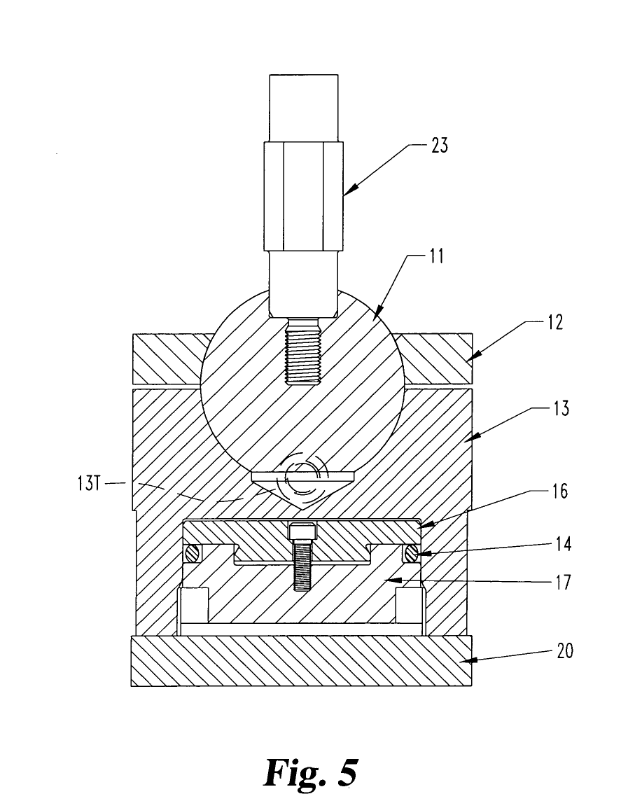

A base 20 is fastened to the bottom of the body by three, circularly-spaced socket-head cap screws 19. Four apertures 25 are provided in the corners of the base for easy attachment to a table or other support. It should be understood that the invention incorporating base 20 or other attachment device for it can be oriented and secured in any attitude and still function as desired. Also, a tapped port 13P is provided in the outer wall of the body 13 and communicates with a internal passageway 1 3T opening into the chamber portion of cavity 15 above the cap 16. Port 1 3P is provided to receive a fitting through which pressure can be introduced from an outside source. This is a fluid pressure and may be gaseous or hydraulic, but more likely hydraulic. This pressure may be applied by fluid admitted through a valve in a supply line from a factory pneumatic or hydraulic system (not shown), and released to sump or a return line by the same valve, for example. One of several alternatives is shown in FIG. 6. It connects the body 13 to become part of a small, self contained closed hydraulic system with a manually-operated pump assembly 30, including the pump, an accumulator, gauge, and valve to hold pressure, but operable when desired to release pressure from the clamp piston. Such pump assembly is readily available in the art. It can be purchased finished and can be connected to the locking device with a hose as shown, or can be directly connected to the port 1 3P. An example of such pump assembly is Model No. P-142 manufactured by Enerpac of Butler, Wisconsin.

A maximum possible spacing between the piston cap and the piston is established by the tie rod bolts 21. This spacing is such that there is a gap 12G between the bottom of clamp plate 12 and the top of the body 13 when the ball is resting in and supported by the lower socket, and the plate 12 is resting on and supported by the ball, as shown in the drawings. This gap is typically 0.020 inches. When there is no fluid pressure applied to the chamber above the piston in cavity 15, the piston assembly is suspended in the cavity by whatever friction there may be between the body and the piston and seal assembly. In the absence of pressure in the cavity, the limit to possible descent of the piston assembly is reached when the heads of the tie rods 21 seat on the bottom of their receiver recesses in the plate 12. At this time it is desirable that there be at least a little clearance space between the top of the piston seal retainer cap 16 and the downwardly facing top surface of the piston receiver cavity 15. Therefore, normally the socket portion of plate 12 is not tightly engaged with the ball, so that the ball can be swiveled rather freely, but preferably not loosely, in the lower and upper portions of the socket.

An object support is shown in the form of a post 23 screwed into a hole in the ball so that it is tight in the ball and projects from the ball and away from the body 13. It has an object receiver in the form of a threaded socket 23S at the top, by which an object to be positioned can be fastened with a bolt or a screw. This object can be a work-piece or a tool or another holding or clamping device or about anything that is to be positioned and held in a certain position in space with a certain orientation at that position. The object receiver can be a variety of devices other than a threaded socket. Also, the object support can be other than a solid post.

In use, either an object to be used or treated is fastened to the post, or some other holding device can be fastened to the post. When the user determines and moves the distal end of the post to the position desired for the object to be treated or used, whether the object is mounted directly to the post or to a holding device mounted to the post, the user can then apply pressure to the pressure port 13P by operating a valve on a pressure line or by operating the closed system pressure-applying pump. When the pressure is applied, the piston 17 is driven in a downward direction forcing the tie rod bolts to pull the plate 12 in a downward direction which clamps the upper socket portion onto the ball 11 and thereby clamps the ball into the lower socket portion. The clamping holds and locks the post securely in the selected attitude until the pressure is released. If there is a desire to lock the post in the selected attitude without concern about possible reduction or loss of fluid pressure during the passage of time, three auxiliary clamp screws 22 (typically socket head cap screws) shown dotted in the drawings, can be screwed into the body 13 to the extent that their heads seat on the bottom of their head-receiving recesses in plate 12, pulling the plate 12 toward body 13 and thereby mechanically supplementing the hydraulic clamping of the plate onto the ball and the ball onto the socket in the body 13. This will keep the ball locked, even if the pressure on the piston is released.

Various sizes of devices may be built according to my invention. Ball diameters of 1.75 inches, 3 inches and 5 inches currently seem desirable for most applications. Materials for fasteners are preferably steel. For the ball, post, body and piston, anodized aluminum works. The clamping plate might preferably be hardened steel. For the piston seal, a square cross section of ‘Teflon” brand material works. A pressure capability of up to 5000 pounds per square inch (psi) seems appropriate. The locking force of the plate on the ball will depend on the pressure applied and the area of the piston. A force of 15000 pounds can be achieved easily. Obviously many other materials and sizes and pressures may be chosen and used depending on the needs of the user. The location of the post on the ball enables the post to swivel about the combination socket portions in a 360 degree circle and to rotate 360 degrees about any radius line from the center of the combination socket portions. The center of the ball is at the center of the socket portions when the ball is clamped. Even when the pressure is released from the piston, the ball continues to rest in the lower socket portion, and the upper socket portion will usually remain centered on the ball, so the center of the socket portions remains effectively the center of the ball. The user can move the object-fastening portion of the post in a conical space definable by a radial line from the center of the ball to the object-fastening portion of the post. When the user does this, the post can also be rotated about the radial line to thereby achieve not only the desired position of an attached object in space, but also the desired attitude of the object when in that position. It should be recognized that the means for mounting the object is not necessarily a post, as shown, or a straight member. Also, the apex angle of the conical volume which can be swept during swiveling will depend upon the size and shape of the opening in the top of the plate through which the object mount extends, and the size and shape of the object mount itself where it extends through the opening.

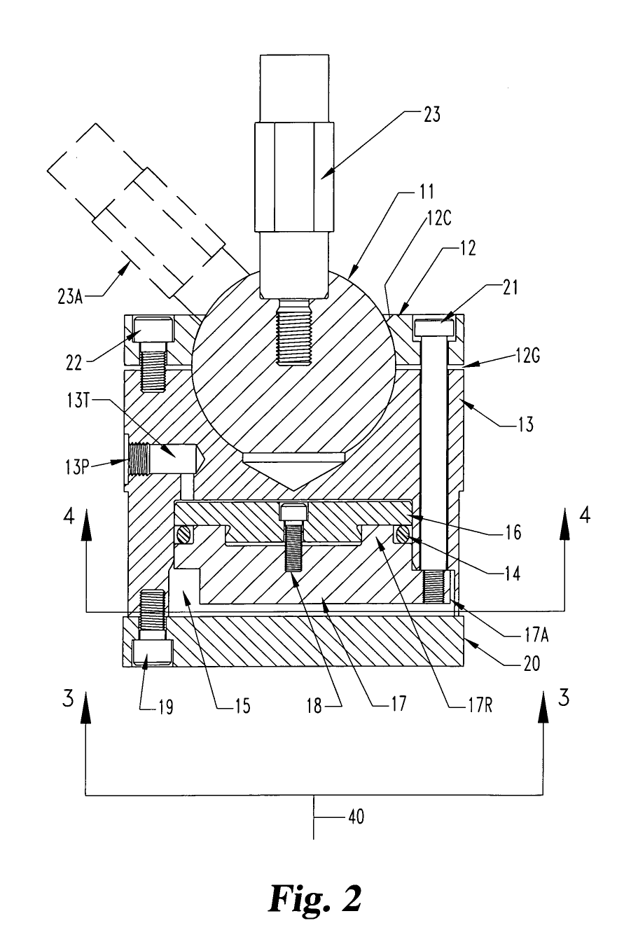

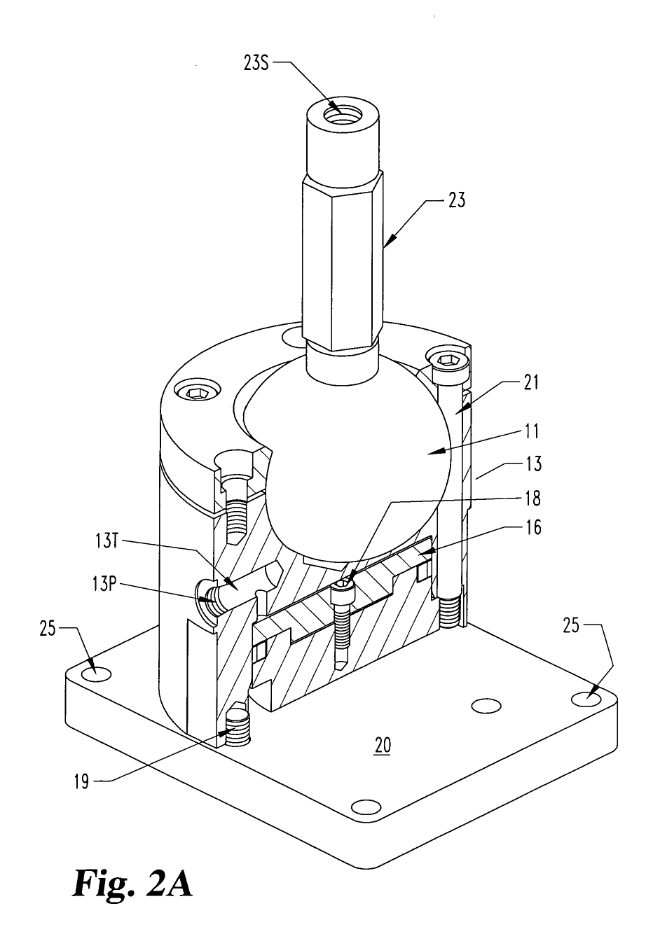

In the illustrated example where the opening 12C in plate 12 is round, and the post version of an object mount has a round portion at the opening, the sizes are selected so that the apex angle of the cone is preferably a minimum of 90 degrees. The dotted line 23A in FIG. 2 is an example of the limit of travel to the left side of the cone at 45 degrees from the vertical center line 40 of the assembly. A larger size opening 12C, or a lesser diameter of the post at the opening, would enable a wider apex angle of the possible sweep of the post.

One or more of the devices according to the present invention may be used together for additional articulation from a fixed attachment location to an ultimate position and orientation for the object or objects to be held and positioned.

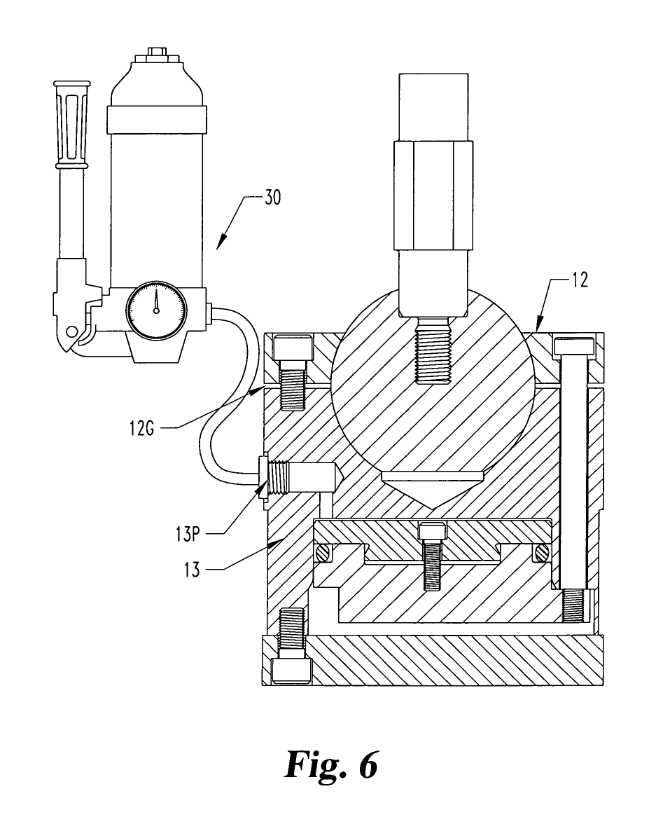

Referring now to FIG. 7, most of the components therein are basically the same or very similar to those shown in FIG. 2, so will be given the same reference numerals as in FIG. 2. But the piston 35 is different in the respect that it has a centrally located, downwardly opening cavity 36 in the bottom receiving a piston bias return spring 37. The piston is also manufactured in one piece, in contrast to the two piece piston shown in FIG. 2.

The new feature of the return biasing spring assists in release of the clamp upon release of fluid pressure from the port 13T. This assistance overcomes any resistance of the seal 14 to return of the piston and the clamp to the ball releasing position, to restore the gap 12G between the clamp plate 12 and the body 13. The force applied by the spring 37 is relatively small, being no more than necessary to overcome the frictional resistance of the seal to the rise of the piston to an unclamping condition when the fluid pressure is released.

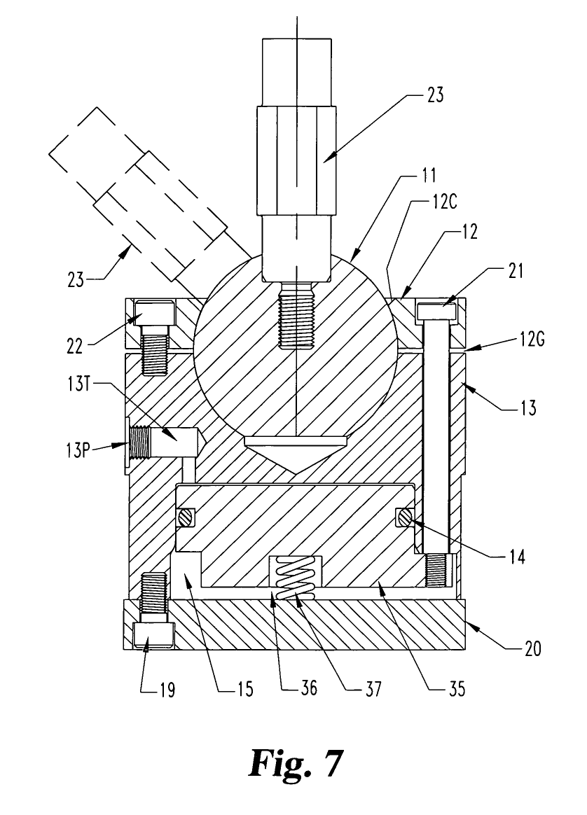

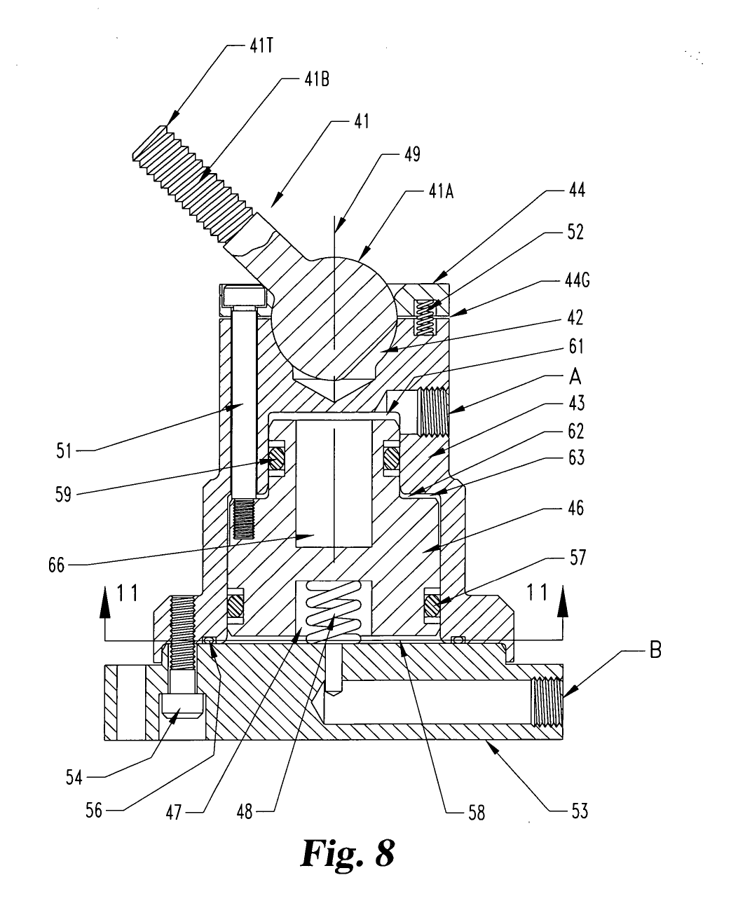

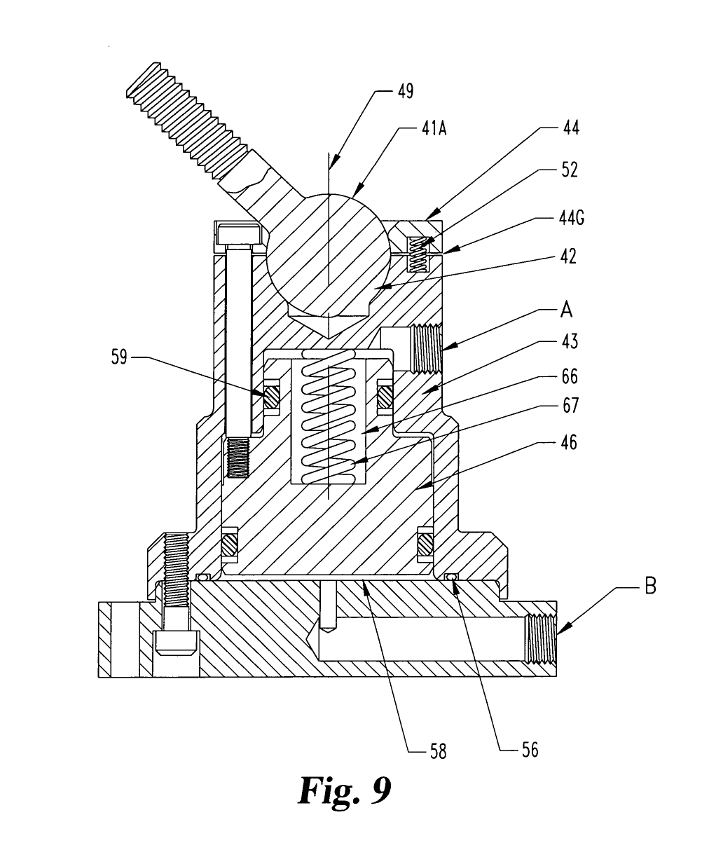

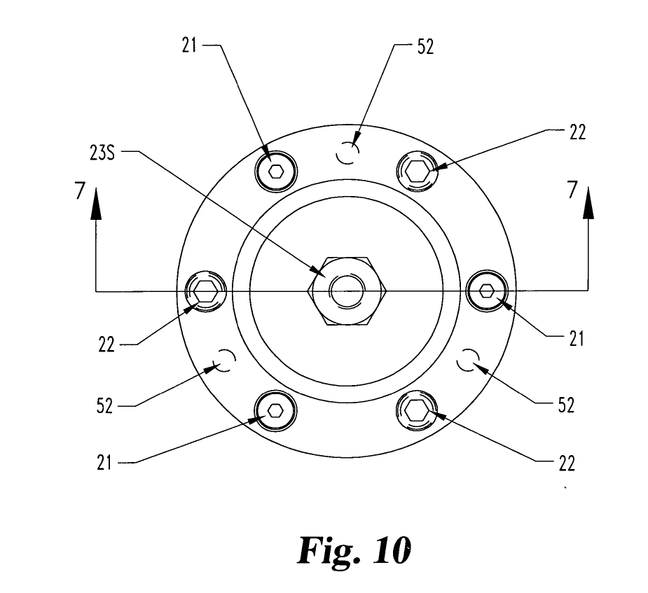

Referring now to FIG. 8, although many components are similar to those in the previously described figures, some have enough differences from those previously described that all will be given new reference numerals. This embodiment of the invention incorporates a ball and post as one piece 41 having the ball portion 41A and post portion 41B which is externally threaded at 41T. It is received in a part spherical socket 42 in body 43. It is trapped in the socket by the clamp plate 44. But as is true in the FIG. 7 embodiment, piston 46 has a centrally located, downwardly opening cavity 47 receiving a piston return bias spring 48. The clamp plate 44, like the body, piston, and return spring cavity is cylindrical and centered on the axis 49. The plate is secured to the piston by three circularly spaced tie bolts 51 in the same manner as in the previously described embodiments. However, in this embodiment, as could be done in the previously described embodiments and is shown in dashed lines in FIG. 10, three clamp lift springs 52 are circularly spaced around the axis 49 in the same manner as the auxiliary clamp screws 22 are located and spaced in the previously described embodiments. In the FIGS. 8 and 9 embodiments, clamp screws 22 are situated around the axis in a manner as shown in FIG. 10. Tie bolts 51 are situated in the same manner as are the tie bolts 21 in FIG. 10. It should be understood that clamp lift springs 52 can also be used in combination with auxiliary clamp screws such as 22 in the same locations, if desired.

The embodiment of FIG. 8 also includes the end cap portion 53 of the body fastened to the bottom of the body 43 by three circularly spaced cap screws 54 located as are the cap screws 19 in FIG. 2. A face seal ring 56 seals the body 43 to the body end cap portion 53.

In this embodiment, the body cavity is in the form of a stepped internal cylinder. The piston has a stepped external cylinder form. It does not have arms such as 1 7A in the FIG. 4 embodiment.

The piston has two seal rings on it. The lower seal ring 57 cooperates with the piston and lower portion of the bore in the body to form a lower chamber 58 under the piston. The upper seal ring 59 cooperates with the upper portion of the bore in the body to form an upper chamber 61. Threaded upper port A communicates with upper chamber 61. Lower threaded port B communicates with the lower chamber 58.

In operation, after the object mounted to the post 41B is situated by the user in the orientation and position desired, fluid pressure is applied in port A. The fluid may be a liquid or a gas, typically oil or air. The pressure will drive the piston down until the part spherical surface in the clamp plate 44 forces the ball tightly against the part spherical socket in the body 43, locking the post in the selected position. It will remain so locked until pressure is released.

To unclamp the ball, pressure is released from port A and introduced through port B, pushing the piston upward, thus moving the tie bolts upward with it. A slight assist is provided with the piston return spring 48 and the lift springs 52. As the tie bolts rise, they enable the clamp lift springs to push the clamp plate 44 upward and sufficiently away from the ball to enable freely moving the post to any other position desired. The upper limit of travel of the piston and thereby the tie bolts, is limited by engagement of the upper end of the piston with the upper end of the upper cylinder portion in the body or by the shoulders 62 of the piston with the step 63 in the cylinder wall of the body. This, will of course, limit the gap 44G between the bottom face of the clamp plate 44 and the top face of the body.

By providing the double acting cylinder arrangement, this device can be hooked up to a fluid pressure source through a selector valve to, in one valve position, pressurize one port and dump the other, for clamping the ball and, in another valve position, dump the one port and pressurize the other to enable unclamping.

Referring now to FIG. 9, many of the parts are the same as shown and described with reference to FIG. 8, so are given the same reference numerals. However, in this embodiment, the device is arranged to be normally clamped without the application of fluid pressure, and released only upon application of fluid pressure. In this embodiment, the centrally located upwardly opening cavity or pocket 66 in the piston 46 receives a piston clamping bias spring 67. This spring normally biases the piston downward so that the clamp plate 44 forces the ball tightly against the socket 42 in the body 43. In order to release the clamp plate, fluid pressure is applied in port B, applying sufficient pressure in chamber 58 to force the piston up and overcome the downward bias of spring 67 and thereby force the tie bolts upward, enabling the clamp lift springs 52 to raise the clamp plate 44 and re-establish the gap 44G, thus assuring that the clamp is sufficiently released from the ball to enable the user to freely move the post to another position. It will be understood, that the port A is not used for pressure application clamping in this embodiment. Also, although it is shown in this FIG. 9, the upper seal 59 is not needed.

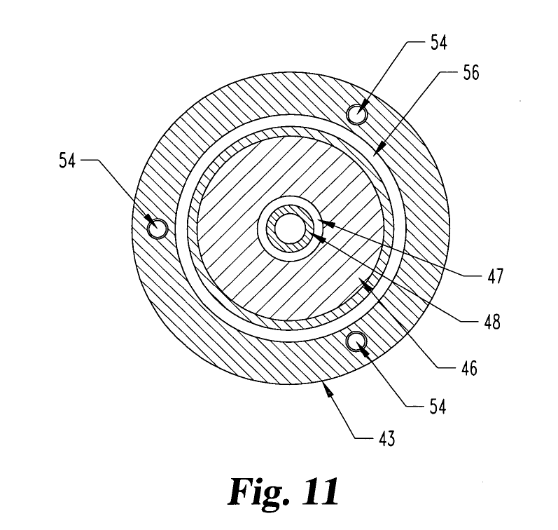

Referring now to FIG. 12, although many components are similar to those in the previously described figures, some have enough differences from those previously described that all will be given new reference numerals. This embodiment of the invention incorporates a ball and post as one piece 71 having the ball portion 71a and post portion 7lb. Piston 73 contains a piston return bias spring 75 and a piston bias plunger 78. The ball and post assembly 71a is received in a concave cavity of bias plunger 78. The ball portion 71a also contacts concave portion 73a of piston 73 and concave portion 80a of body 80. Body 80 containing piston 73 rests in base portion 76.

The FIG. 12 assembly includes two annular sealing rings 72 and 81. Annular sealing ring 72 is positioned in an annular groove formed in body 80 to seal between body 80 and base 76. Annular sealing ring 81 is positioned in an annular groove formed in piston 73 to seal between piston 73 and body 80. Fluid port E is in flow communication with the interior of body 80.

In operation, after post 71b is manually set by the user in the desired orientation and position, fluid pressure is applied through port E to clamp assembly 71 in position. The fluid passes into the body 80 through port E and into gap 82 where it exerts a force on piston 73 moving piston 73 upwards, thus locking the ball and post assembly in the predetermined position. This arrangement eliminates the use of tie bolts. The bias spring 75 pushes the bias plunger 78 upwards to assist in the clamping. The ball and post assembly remains locked until pressure is released. The concave cavity of bias plunger 78 pushes against a matching convex portion of ball 71a. The bias spring 75 is selected to apply a no-load force on assembly 71 that exceeds the gravitational weight of the ball and post assembly.

To unclamp the ball 71a, the fluid that was introduced via port E is allowed to flow in the reverse direction, releasing the piston 73. In cooperation with the gravitational force, the bias spring 75 pushes the piston 73 in a downward direction away from the ball leaving only the bias plunger 78 to apply a resistance to the ball and post assembly 71. There is very little travel of piston 73 toward surface 80b between unclamped and clamped positions. This limited amount of travel allows the invention to respond faster and requires less fluid to clamp the ball and post assembly.

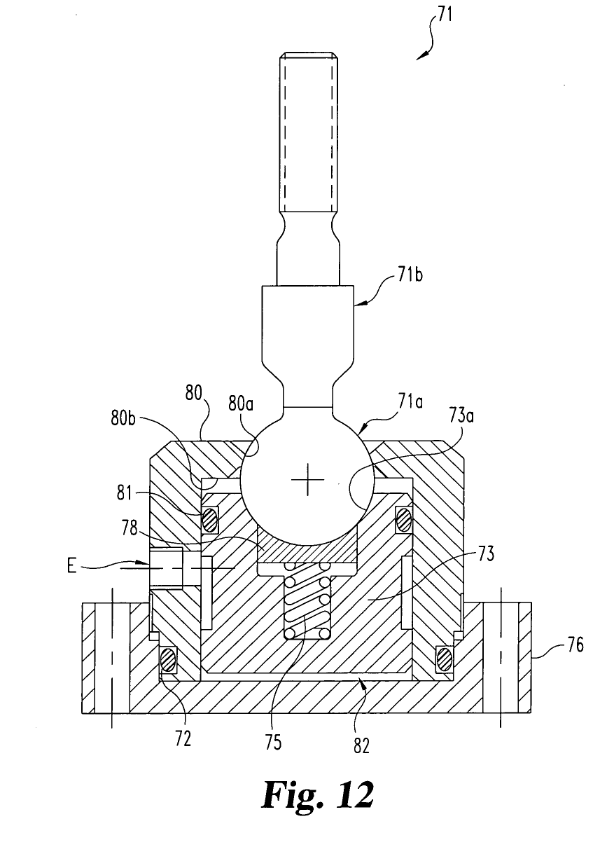

Referring now to FIG. 13, many of the parts are the same as shown and described with reference to FIG. 12, and are given the same reference numerals. However, in this embodiment, ball and post assembly 91 (i.e., the mounting assembly) is a hollow member including set screws 88 and 89, a spring compressing rod 92, a spring 85, and spring-biased plunger 86. The externally threaded portion 93 is used to attach an object to the object mounting post 91b. The adjustable set screw 88 is a force adjustment feature used to vary the spring force which assists in positioning the ball and post assembly 91 before an object is mounted. An optional second set screw 89 can be used to prevent loosening of set screw 88. The bias spring 85 and bias plunger 86 are located inside ball 91a, and comprise the base subassembly of the mounting assembly. Hydraulic fluid enters through port E in the same manner as shown in FIG. 12 to push the piston 74 upwards thus clamping the ball and post assembly in its predetermined position.

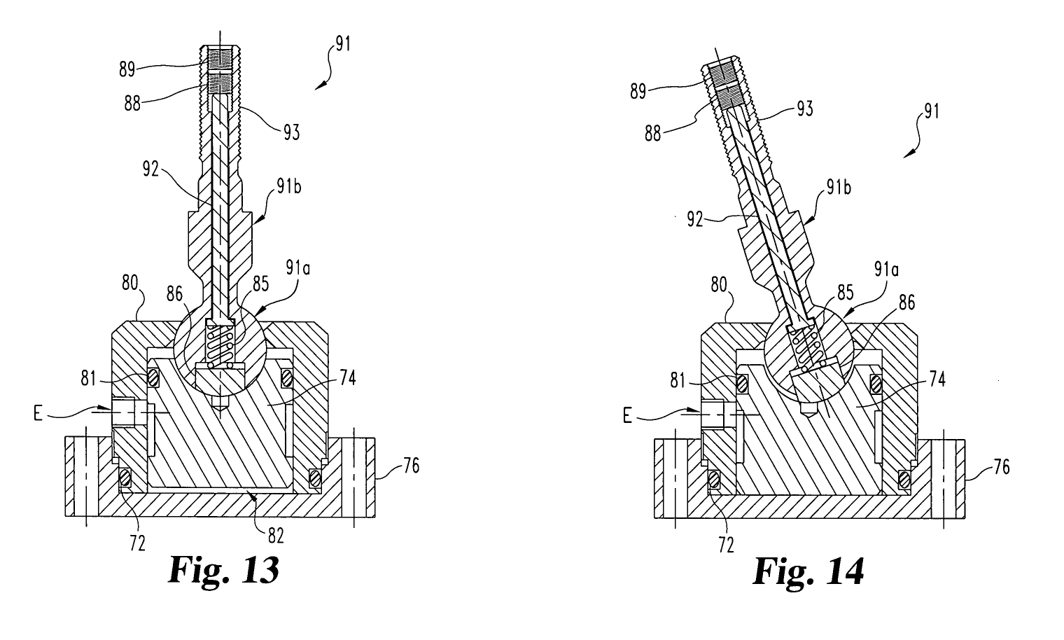

Referring now to FIG. 14, when the hydraulic fluid is released and piston 74 is in the down position, the spring-biased plunger 86 extends outwardly from ball 91a to maintain contact with piston 74. This arrangement keeps the ball 91a from also moving downward so as to enable the user to move the post to another position. The spring force that is exerted to create a frictional force on the ball 91a exceeds the gravitational force on the assembly 91 so that the assembly will remain in the orientation selected by the user. When the piston 74 is in the down position, only the bias plunger 86 is touching piston 74, keeping the ball and post assembly 91 from moving on its own. The adjustable set screw 88 exerts a force on the spring compression rod 92, which exerts a force on bias spring 85, which then exerts a force on bias plunger 86, which then exerts a force on piston 74, thus holding the ball and post assembly in a predetermined position. The force exerted by adjustable set screw 88 can be varied depending on the desired stability of the ball and post assembly 91 and external factors such as changes to the spring 85 due to temperature.

In view of the foregoing, and while the invention has been illustrated and described in detail in the drawings and foregoing description, the same is to be considered as illustrative and not restrictive in character, it being understood that only the preferred embodiments have been shown and described and that all changes and modifications that come within the spirit of the invention are desired to be protected.

1. An object holding device comprising:
an object mounting member having a generally spherical base and a mounting post;
a support member constructed and arranged to support said generally spherical base;
a cover portion cooperatively arranged with said support member to capture said generally spherical base; and
said support member including a concave portion constructed and arranged to be in direct contact with said generally spherical base.
